(19) United States
(12) Patent Application Publication
(10) Pub. No.: US 2013/0254761 A1
(43) Pub. Date: Sep. 26, 2013

(54) GRANULAR APPLICATION SESSIONS TAGGING

(71) Applicants: Krishna Reddy, Irvine, CA (US); Zaheeruddin Syed, Roswell, GA (US); Shivinder Singh, Woodbury, MN (US)

(72) Inventors: Krishna Reddy, Irvine, CA (US); Zaheeruddin Syed, Roswell, GA (US); Shivinder Singh, Woodbury, MN (US)

(73) Assignee: Cellco Partnership d/b/a Verizon Wireless, Basking Ridge, NJ (US)

(21) Appl. No.: 13/425,124

(22) Filed: Mar. 20, 2012

(51) Int. Cl. G06F 9/455; G06F 15/16

(52) U.S. Cl. 718/1

(57) ABSTRACT

Systems and techniques are provided for identifying and tracing an individual session of a web application hosted at a server in a network communication system, based on a request message from a client requesting a function of the web application. Data stored in a database may be accessed by one or more virtual machines executing at the server via one or more data connections from a connection pool allocated to each of the virtual machines. Reference and logging information are stored for each virtual machine and corresponding connection pool, thereby enabling operations performed by each virtual machine for the requested function to be traced with a relatively high degree of granularity at each of various functional layers or tiers of the network communication system.

### BACKGROUND

Many advanced network systems enable clients or user systems to access various web applications or services through a communication network. Due to the continued growth and use of such network-based applications, middleware technologies are increasingly playing a vital role in facilitating communications between clients and the web servers that host these applications. Such middleware technologies may include connection pooling techniques for establishing and managing data connections that facilitate client-server network communications. For example, such connection pooling techniques may mitigate the overhead associated with a large number of data connections by spreading the number of established connections across several processing units and over multiple requests, thereby conserving network system resources and improving efficiency for handling additional requests.

However, the growth in middleware or middle tiers of a multi-tier network environment has increased the complexity of these communication systems, and thus, has posed significant challenges to effectively maintaining system security. For example, different application servers may be used to establish database connectivity with multiple data connections allocated from a single connection pool. Due to the relative complexity of the application servers, each of which may be executing multiple processes using multiple data connections, it can be difficult using conventional solutions to identify which specific network resource(s) may have been accessed by a client during any particular session of application use.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary communication network system having different functional layers for providing a variety of communication services, including communications for a web application provided by an application layer of the system to one or more clients.

FIG. 2 is a block diagram of an exemplary server cluster system for implementing the application layer of the network system of FIG. 1 using Java Virtual Machines (JVMs).

FIG. 3 is a functional block diagram of an exemplary connection pooling system for managing data connections between the application layer and a database layer of the network system of FIG. 1.

FIG. 4 is a flowchart of an exemplary process for initializing one or more database connections for a Java Virtual Machine (JVM) in the connection pooling system of FIG. 3 using a JVM startup script.

FIG. 5 is a flowchart of an exemplary process for initializing a connection pool for the JVM of the exemplary process of FIG. 4.

FIG. 6 is a flowchart of an exemplary process for establishing one or more database connections from a connection pool associated with the JVM of the exemplary process of FIG. 4.

FIG. 7 is a simplified functional block diagram of an exemplary computer that may be configured to host a service, for example, to function as an application or web server in the system of FIG. 1.

FIG. 8 is a simplified functional block diagram of an exemplary personal computer or other work station or terminal device.

### DETAILED DESCRIPTION OF PREFERRED EMBODIMENTS

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings. The detailed description below uses a number of terms with respect to various system components and operations. Although generally known, use of several of these terms may not be strictly standardized in the art. For the convenience of the reader, the following definitions for some of the relevant terms are presented, as used by way of example in the detailed description below.

The systems and techniques disclosed herein enable an individual session of a network-based or web application hosted at an application server to be identified and traced with a relatively high degree of granularity. The session is initiated by a client based on a request message from the client through a communication network to the application server. The application server may be implemented in an application layer or tier of a multi-tiered network communication system that provides web application functionality to clients. Thus, operations performed in the application layer and in each of the various functional layers of the network communication system may be traced so as to identify the source of any potential issues within the system for purposes of troubleshooting such issues or handling exceptions or faults that may occur in the system during a session of the web application. As will be described in further detail below, in addition to the application layer, other examples of different functional layers of the network system may include, but are not limited to, an authentication layer and a database layer. Also, as will be described in further detail below, the techniques described herein may be used to identify one or more servers within a cluster of a clustered computing environment in the application layer, an individual server within such a cluster and an individual virtual machine executing at the server, from which operations to a database in the database layer are originating via a data connection from a connection pool of data connections allocated to the virtual machine during a session. An advantage of these techniques relative to conventional solutions is that they may be implemented within an existing framework or system architecture of the network environment, without having to make changes to the programming or code of the network-based/web application itself.

The terms “application,” “network-based application,” “web application,” and “web service” are used interchangeably herein to refer broadly and inclusively to any unit of software functionality that is exposed to at least one other service, application program, or system on a local area network, wide area network, or even a single process. For example, the functionality of such a web application or service may be provided to one or more clients via an interface described in a machine-readable format, for example, the Web Services Description Language (WSDL). A web application generally passes messages (e.g., requests and responses) to and from clients as a form of communication through the communication network. Furthermore, the communication network can include, but is not limited to, the Internet or World Wide Web, and the web application can be hosted at an application server configured to exchange communication with clients (or client applications) over the Internet. The web application or service may use a number of different technologies and message-communication protocols for providing web application functionality across the network. Examples of such technologies may include, but are not limited to, Hyper-Text Transfer Protocol (HTTP), Simple Object Access Protocol (SOAP), Service Oriented Architecture, Web 2.0 application features and Lightweight Directory Access Protocol (LDAP). Further, messages transmitted across the network may be formatted using any of various markup, scripting or other programming languages including, for example and without limitation, Hyper-Text Markup Language (HTML), extensible markup language (XML) and JavaScript.

The term “client” is used herein to refer broadly to any process configured to consume a functionality of a web application offered by an application server. For example, when a client uses an application, the client is generally utilizing at least one function of the service. Such a client may be executed at any type of computing device including, for example and without limitation, a desktop computer or workstation, a mobile device, or a host or network device that may operate at other times as a server to other clients. Such a server may be any type of computing device capable of communicating data to one or more clients over a communication network. Further, a client can be any type of remote or local process with respect to the computing device executing or hosting the service. Also, a client can be another application or service. With respect to client access, the term “authentication” is used herein to refer generally to the function of verifying the identity of a client for purposes of allowing access to the functionality provided by an application.

The term “middleware” may be used to refer generally to the architecture or infrastructure of the network environment that enables network communications between clients and servers (e.g., application servers), as described above. For example, middleware may provide the framework for service-oriented architecture (SOA) applications as well as various transaction and data management functionality including, for example and without limitation, concurrency control, multi-threading and message-handling in a client-server network environment. Some middleware components also may be used to provide security and fault-tolerance features for improving the availability or reliability of the functionality provided by the network environment. In some implementations, middleware components may be implemented as the functional layers or tiers of a multi-tiered system for providing web application functionality to one or more clients, as described above. Reference now is made in detail to the examples illustrated in the accompanying drawings and discussed below.

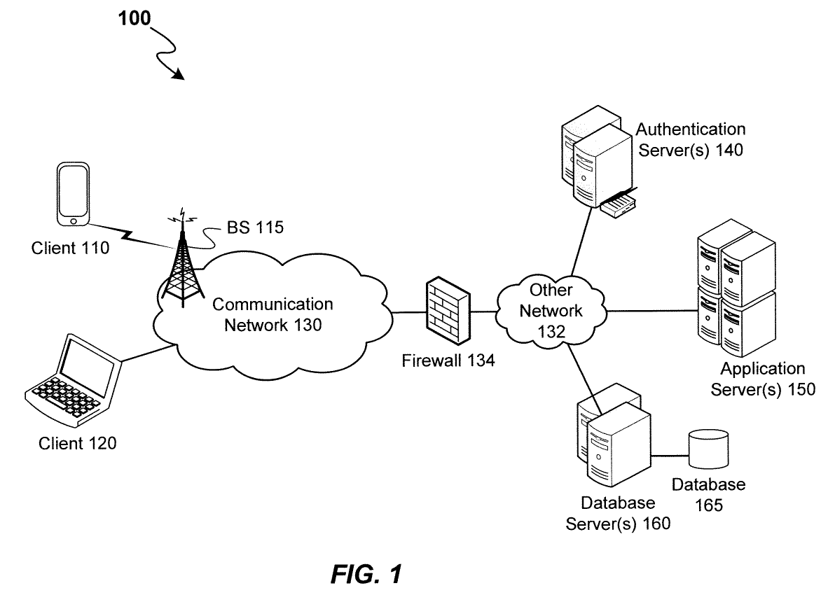

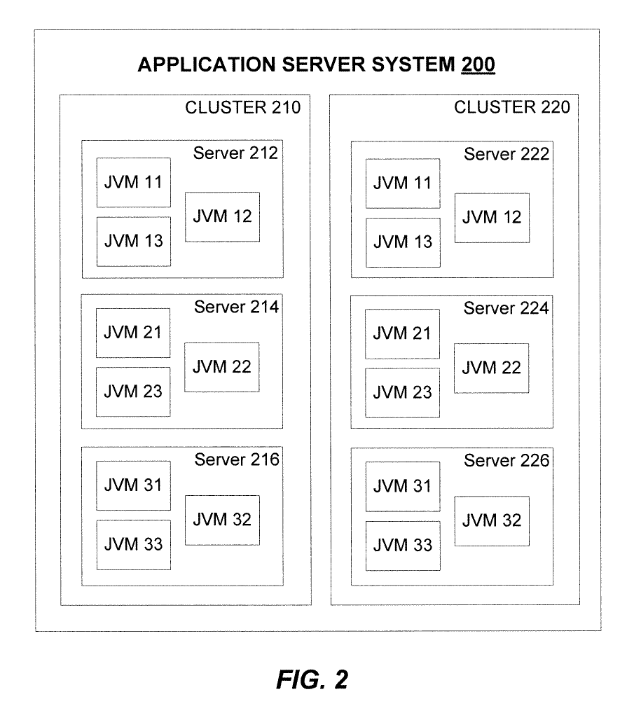

An exemplary network communication system 100 having different functional layers for providing a variety of communication services, including communications for a web application provided by an application layer of the system to one or more clients is described initially with respect to FIG. 1. Examples of such communications may include, but are not limited to, communications for authentication and management of one or more clients' access to the functionality of the web application, e.g., hosted at one or more application servers in communication system 100. Following the description of communication system 100, examples of various system components and processes related to the different functional layers will be described further below with respect to FIGS. 2-8.

In the example illustrated in FIG. 1, network system 100 includes a client 110 and a client 120, which are communicatively coupled to one or more authentication server(s) 140, application server(s) 150 and database server(s) 160 through a communication network 130. As shown in FIG. 1, authentication server(s) 140, application server(s) 150 and database server(s) 160 are communicatively coupled to each other via another network 132 (e.g., a private network) including a firewall 134. As described above, network system 100 may be a multi-tiered enterprise system having different functional layers for providing various functionality of a web application to each of clients 110 and 120. For example, authentication server(s) 140, application server(s) 150 and database server(s) 160 may represent an authentication layer, an application layer and a database layer, respectively, of such a multi-tiered enterprise system. Further, authentication server(s) 140, application server(s) 150 and database server(s) 160 may be part of a middleware platform including additional web servers, application servers, content management systems, and similar tools that support web application functionality and content delivery.

Communication network 130 of system 100 facilitates communications between various types of clients and at least one server for purposes of client access to the functionality of the web application hosted at application server(s) 150. Such functionality can be implemented in the form of one or more processing functions accessible to each of clients 110 and 120 via, for example, an interface or client application executed at each of clients 110 and 120. In addition, network 130 further supports communications for other devices that do not execute client applications or participate in any particular web application hosted at any of application server(s) 150. Network 130 can be any network or combination of networks in an overall communication network for transmitting data communications between various devices associated with the communication network. Each of network 130 and network 132 can include, but is not limited to, a wired (e.g., Ethernet) or a wireless (e.g., Wi-Fi or 4G) network. In addition, network 130 and network 132 can each include a local area network, medium area network, and/or wide area network. Network 130 and network 132 can each support protocols and technology including, but not limited to, Internet or World Wide Web protocols and communication services. Intermediate network routers, gateways, or servers may be provided between components of network system 100 as may be necessary depending upon a particular network implementation or computing environment.

While the example in FIG. 1 shows only clients 110 and 120, network system 100 can be used to facilitate data communications for additional client devices (not shown) over communication network 130. Similarly, system 100 can include other servers in addition to servers 140, 150 and 160 for providing web application functionality to one or more of the client devices. Furthermore, the present techniques may be implemented in communication network 130 using any of a variety of available communication networks and/or on any type of computing device compatible with such a network. As such, FIG. 1 is used herein to provide only a very simplified example of a few relevant elements of system 100 and network 130, for purposes of discussion and ease of explanation.

The clients 110 and 120 are examples of two types of client devices that may be used for communicating request messages to the web application hosted at application server(s) 150. In the example shown in FIG. 1, client 110 is a mobile station or device for accessing mobile wireless communications services through communication network 130, for example, via one or more base stations 115. Thus, client 110 can be any type of mobile computing device capable of data communications over one or more networks. Examples of such mobile computing devices include, but are not limited to, portable handsets, smart-phones, tablet computers, and personal digital assistants. Similarly, client 120 can be any type of general purpose computing device, such as a notebook, laptop or desktop personal computer. An exemplary implementation of such client devices will be described further below with respect to FIG. 8.

The functionality of a particular web application is generally provided for the benefit of a user of either client 110 or 120 via a client application program, process, or interface that is executed at each of clients 110 and 120 for enabling data communications with the associated application server(s) 150 through communication network 130. For example, a client application program may be implemented on either of client 110 or client 120 as a web interface to access different functionality of the web application hosted at application server(s) 150. Such a web interface may be provided to each respective user of clients 110 and 120 through a web browser application executable at each of clients 110 and 120. Alternatively, the client application program may be a dedicated application program that is installed and executable at each of clients 110 and 120, specifically for enabling the user to access web application functionality.

In operation, each of clients 110 and 120 may access one or more processing functions or resources provided by the web application by sending request messages through communication network 130. The request message from client 110 of client 120 may include information identifying the particular client including, for example and without limitation, user credentials, an Internet Protocol (IP) address, client domain name and any other client-specific information. The request message may be formatted in any number of well-known formats in accordance with one or more network communication protocols used for sending communication requests for accessing the functionality of a web application or service hosted at one or more servers in the network. As noted above, examples of such technologies may include, but are not limited to, HTTP, SOAP, Service Oriented Architecture, Web 2.0 application features and LDAP.

In the example shown in FIG. 1, authentication server(s) 140 may be configured authenticate or validate the credentials of clients 110 and 120 or other clients (not shown) to ensure that the web application offered by application server(s) 150 is available only to authorized clients. For example, authentication server(s) 140 may be one or more separate physical servers communicatively coupled to application server(s) 150 and database server(s) 160 via network 132. Alternatively, the authentication or client validation process may be implemented at application server(s) 150 as, for example, an authentication program module executing on the same hardware platform as one or more of application server(s) 150. Clients 110 and 120 may be authenticated by authentication server(s) 140 initially, upon establishing a data connection, in order to verify the client's identity, based on the client-specific information associated with the respective communication request messages from clients 110 and 120, as described above.

In some implementations, application server(s) 150 serves as an interface between clients 110 and 120 and database server(s) 160. For example, data associated with the web application may be stored in a database 165 coupled to database server(s) 160. The application server(s) 150 may then connect to database server(s) 160 (e.g., via network 132) to obtain the data and provide it to clients 110 and 120 through communication network 130. The application server(s) 150 may be implemented as an application processing framework including a collection of programs, routines or scripts that enable users at each of clients 110 and 120 to create, store or modify data (e.g., stored in database 165) associated with the web application. In some implementations, the application server(s) 150 may operate similar to an extended virtual machine for executing various functions associated with the web application. Such functions may include, for example and without limitation, establishing and managing back-end data connections (e.g., to database server(s) 160 or database 165) in addition to front-end or client-side data connections to each of clients 110 and 120 via network 130. Examples of additional functions that may be performed by application server(s) 150 may include, but are not limited to, validating client credentials based on a client request received through network 130, as described above, connecting to one or more of database server(s) 160 in response to the client request, and performing one or more requested operations based on the received request.

As will be described in further detail below with respect to FIG. 2, application server(s) 150 may be implemented as a group of servers in a clustered computing environment (or server farm) including a plurality of virtual machines, e.g., Java Virtual Machines (JVMs). Such an application server cluster may be configured to perform various multi-tasking operations including, for example and without limitation, data clustering, fail-over and load-balancing. A benefit of such an implementation of application server(s) 150 is that it allows enterprise application developers to focus more on implementing application functions for the business logic of an enterprise organization, rather than implementing functions for supporting the particular infrastructure of the enterprise application environment.

FIG. 2 is a block diagram of an exemplary application server system 200 including a cluster of servers for implementing the application layer (e.g., application servers 150) of network system 100 of FIG. 1, as described above. As shown in FIG. 2, system 200 includes a cluster 210 of servers 212, 214 and 216 and a cluster 220 of servers 222, 224 and 226. Also, as shown in FIG. 2, each of the servers within clusters 210 and 220 are configured to execute a one or more JVMs. Although not shown in FIG. 2, it should be noted that system 200 may include additional clusters, servers or JVMs, as may be desired.

Each JVM of an application server within a cluster of system 200 may be implemented in software using physical hardware or computing device for executing the software as well as an operating system of the device. The application servers 212, 214, 216, 222, 224 and 226 use the various JVM for performing different operations so as to implement application functionality using multi tasking and concurrency control. For example, a JVM may provide a virtual computing platform for implementing various features related to workload management in addition to automated exception handling. Such automated exception handling may provide debugging information for any software errors (or “software exceptions”) that may occur in system 200, independently of the actual source code or programming associated with the web application itself. Further, the debugging information may be used to find the root cause or source of such errors.

The group of servers associated with each of clusters 210 and 220 may function together as a single clustered computing environment for managing data flow and processing communication requests from one or more clients (e.g., client 110 or client 120 of FIG. 1, as described above). Accordingly, the individual application servers within clusters 210 and 220 may represent different processing nodes of the clustered computing environment. Each node or application server may be a physical computer system with a distinct host IP address. Thus, clusters 210 and 220 may be used for balancing workload among servers 212, 214, 216, 222, 224 and 226. Further, the various functions of the web application provided by application server system 200 may be spread across different nodes/servers within clusters 210 and 220 and thus, different JVMs associated with each of these nodes/servers. Clusters 210 and 210 also may be grouped as a single processing unit or group within a larger computing environment that logically associates many servers and clusters arranged in various configurations as desired by, for example, an administrator of system 200. In an example, the nodes of cluster 210 or 220 may be arranged in a master-slave configuration, in which a particular node in the respective cluster functions as a primary node that manages workflow distribution across one or more secondary nodes within the cluster. In some implementations, when an application is installed on a particular cluster, the same application is automatically installed onto each server (or cluster member) of that cluster.

Referring back to FIG. 1, application server system 200 may represent an application layer of network system 100, as described above. Also, as described above, one or more application servers (e.g., application server(s) 150 of FIG. 1) within application server system 200 may be used to process network requests received from one or more clients (e.g., client 110 or 120 of FIG. 1) during a session of application use by each client. Further, application data from a data store (e.g., from database 165 of FIG. 1) of a database layer of the network system 100 may be provided to these clients in response to the received requests. For example, a database server (e.g., database server 160 of FIG. 1) may provide data requested by an application server on behalf of a client. In an example, the application server system 200 assumes the identity of the client when it is performing operations on the database server for that client. Accordingly, the application server's access privileges may be restricted so as to prevent any unauthorized access or undesired operations during a session of application use by the client.

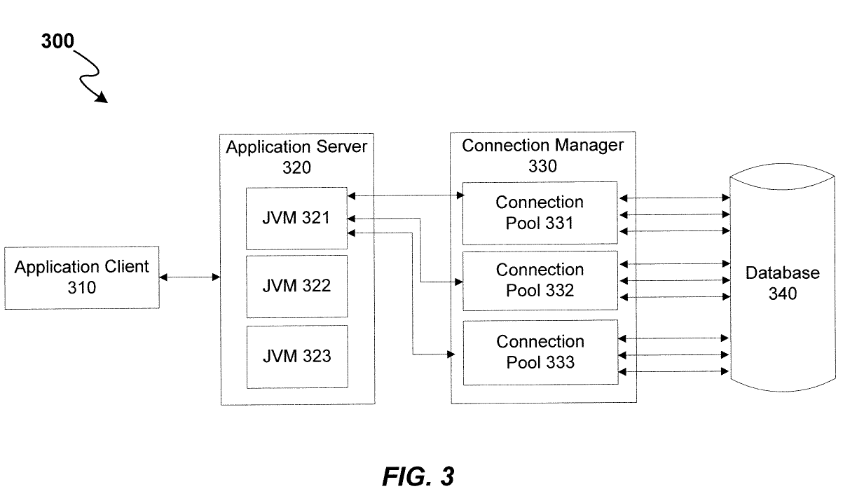

Thus, the application server(s) of the application layer and the database server(s) of the database layer may operate together to dispatch data to a client application program executing at the client. Additionally, various network data communication services may be utilized between the different functional layers (e.g., application and database layers) of the network system 100 in order to establish and maintain one or more data connections between the application server and database server for purposes of exchanging data between one another as well as between the application server and the client (or client application program executing at the client) over a network (e.g., network 130 of FIG. 1). In some implementations, the available data connections for such facilitating data exchange between the different functional layers (including application server system 200) of network system 100, as described above, are provided in one or more connection pools. Additional description of the data exchange using such connection pools will be described in further detail below with respect to FIG. 3.

FIG. 3 is a functional block diagram of an exemplary connection pooling system 300 for managing data connections between an application layer (e.g., implemented using application server system 200 of FIG. 2) and a database layer of the network system 100 of FIG. 1, as described above. As shown in FIG. 3, connection pooling system 300 includes an application client 310, an application server 320, a connection manager 330 and a database 340. Further, connection pooling system 300 may include additional components (not shown) for implementing web application functionality and the techniques as described herein.

In an example, application client 310 may be implemented using client 110 or client 120 of network system 100 of FIG. 1, as described above. However, it should be noted that application client 310 may be implemented using any type of computing device. Such a computing device can include, but is not limited to, a personal computer, mobile device such as a mobile phone, workstation, embedded system, game console, television, set-top box, or any other computing device. Further, a computing device can include, but is not limited to, a device having a processor and memory for executing and storing instructions. Software may include one or more applications and an operating system. Such applications may include a client application program executable on the computing device, which includes an interface enabling a user to access the functionality of a web application hosted at application server 320. Hardware can include, but is not limited to, a processor, memory and graphical user interface display. The computing device may also have multiple processors and multiple shared or separate memory components.

Similarly, application server 320 may be implemented using such a computing device (e.g., application server(s) 150 of FIG. 1). Further, the computing device may be part of, for example, a clustered computing environment or server farm. As such, application server 320 may be implemented using application server system 200 of FIG. 2, as described above. Although shown separately from application server 320 in FIG. 3, connection manager 330 may be implemented as a module within application server 320. Alternatively, connection manager 330 may be implemented as a module within database server 160 of FIG. 1, as described above. Application client 310 may be communicatively with application server 320 via a network (e.g., network 130 of network system 100 of FIG. 1, as described above). Further, application server 320, connection manager 330 (e.g., executing at database server 160) and database 340 may be communicatively coupled via the same or other network (e.g., network 132 of network system 100 of FIG. 1).

In operation, application client 310 communicates over the network with application server 320 to access the functionality of a web application hosted at application server 320. As shown in FIG. 3, application server 320 includes a JVM 321, a JVM 322 and a JVM 323. As described above, the web application may be implemented across each of JVMs 321-323 of application server 320 for purposes of multi-tasking and workload distribution when processing network requests from application client 310 or other clients. For example, each of JVMs 321-323 may include a copy of the web application and be used to provide the same functionality to various application clients through the network. In a session of use of the web application by application client 310, a network request may be sent from application client 310 to application server 320 (e.g., to one of JVMs 321-323). In response to receiving the request, application server 320 may access application data stored in database 340. To access this data from database 340, a data connection is established with database 340 by application server 320 or by a database server (e.g., database server 160 of FIG. 1) coupled to the database 340. The established data connection may then be maintained for a period of time so as to have a persistent connection for accessing the data during the session.

In some implementations, a pool of backend data connections may be used to mitigate the potential strain on system resources that may be caused by multiple requests for application data by application server 320 in response to requests from application client 310 or other application clients. The available data connections within the pool may be used by application server 320 to process requests from application client 310. For example, the available data connection may be shared across JVMs 321-323. Further, multiple connection pools may be used to improve connection management overhead, e.g., due to a relatively large volume of client requests for accessing web application functionality, as well as system response times for handling such requests. As shown in FIG. 3, connection manager 330 includes a connection pool 331, a connection pool 332 and a connection pool 333. Connection pools 331-333 may each include a plurality of data connections to database 340. Further, any of the data connections within each of the connection pools 331-333 may be available for use by any of JVMs 321-323 of application server 320.

In some implementations, session tracing may be enabled for each session of use of the web application by the application client 310 (or other clients) so as to identify the resources utilized for a task or process initiated in response to a network request from application client 310. For example, the network request from application client 310 may include one or more Structured Query Language (SQL) queries for retrieving or modifying data stored within database 340. Session tracing may be used to identify the SQL queries processed or executed during each session. Additionally, session tracing may be used to identify and track the particular components or resources of connection pooling system 300 that are used in executing each of these queries. Information derived from such session tracing may then be used to extrapolate the amount and distribution of workload within the system at any given period of time (e.g., during one or more sessions). Accordingly, this session trace information may be used to allocate additional system resources or reallocate existing resources (e.g., by assigning particular data application functions to different JVMs or application servers). This may help to ensure that connection pooling system 300 can sustain a certain amount or level of workload based on, for example, a predetermined number of application client requests that system 300 can handle over a given period of time.

In some implementations, the database 340 provides a client identifier attribute for identifying a particular application client or controlling client access to certain application data during each application session. The client identifier attribute may be, for example, a predetermined numerical or other type of identifier that the application and database layers of the application network system, as described above, may use for purposes of client identification and access control.

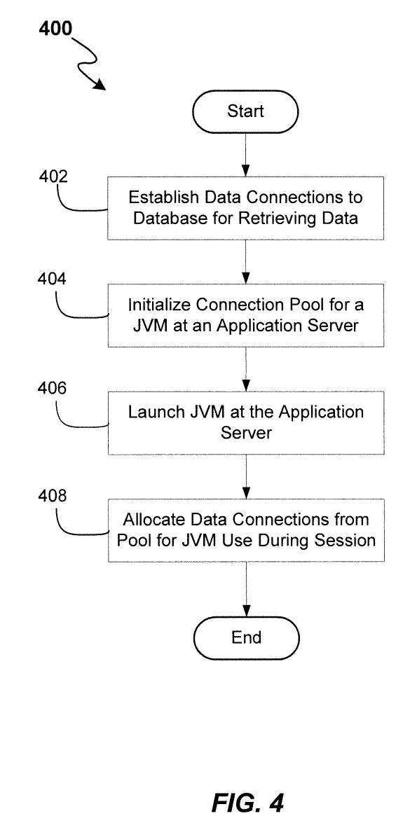

As described above with respect to application server system 200 of FIG. 2 and connection pooling system 300 of FIG. 3, application server architecture may include multiple JVMs executing from each of a plurality of application servers within a clustered computing environment, all of which may be utilizing the same connection pool (e.g., connection pool 331, as shown in the example of FIG. 3) for database connectivity. Due to the relative complexity of such an application server system architecture, the capability to identify and trace the particular system resources used during a single session of application use may not be possible with conventional solutions. In contrast with conventional session tracing solutions for connection pools, the present techniques, as described above and as will be described in further detail below with respect to FIGS. 4-6, provide a greater level of granularity for identifying which application client, server, JVM or other system component is using particular system resources (or consuming a relatively large amount of these resources) or from which a particular request (e.g., SQL query) may have originated for each individual session.

Further, the processes 400, 500 and 600 of FIGS. 4-6, respectively, as will be described below, may be implemented within a current or existing application server architecture so as to enable session tracing capabilities to identify and trace individual application sessions at the database level, without requiring any changes to the code implementing the functions of the web application that are provided to the user. For example, these processes may be parts of an overall method that can be used to identify a server cluster, a connection pool, a physical application server and the individual JVM associated with a session. As will be described in further detail below, the overall method involves a different initialization process for each of the database functional layer and the application functional layer of a web application network system (e.g., network system 100 of FIG. 1, as described above). In some implementations, the initialization processes may be relatively quick and easy to perform and may be performed only once, e.g., during the initial setup of the database and application layers. However, these initialization steps may be modified in accordance with any changes made in the application network system. Once this setup is complete, each time a JVM starts (e.g., by launching an instance of the application executable by the JVM) or ends, all sessions associated with that JVM may be identified or traced, as described above.

The initial setup of the database layer of the web application network system (e.g., network system 100 of FIG. 1), as described above, may involve performing one or more initialization steps at the database. In some implementations, such an initialization step may include, for example, defining a potential user of the database (e.g., database 340 of the connection pooling system 300 of FIG. 3). For example, a data structure representing a potential database user may include information defining a relationship between one or more JVMs within an application server cluster (e.g., cluster 210 or 220 of FIG. 2) and a connection pool (e.g., connection pool 331 of FIG. 3). The information for such a database user, including the JVM-to-pool relationship, may be stored at either a database server (e.g., database server 160 of FIG. 1) or the database itself (e.g., database 165 of FIG. 1 or database 340 of FIG. 3). Further, this information may be stored for the database user in association with JVM startup details as well as information needed to enable session tracing or event logging features of the system, e.g., for purposes of troubleshooting issues that may arise. Also, session identification information may be stored for the user. Such session identification information may include, for example and without limitation, application routines or procedures involved in creating or defining an identifier for each of the sessions (e.g., by generating and assigning a unique session identifier to the session).

In an example, a reference table may be used to store information related to the system architecture of the clustered computing environment implementing the web application (e.g., application server system 200 of FIG. 2, as described above). The reference table may store, for example, information related to various properties of the application server or server cluster, the JVMs executing at each server or the connection pools associated with each of the JVMs. In addition, the reference table may hold information defining, for example, a predetermined minimum and/or maximum number of data connections from a connection pool that a given JVM may establish or use at any given time. In a further example, one or more additional tables may be used to store information related to JVM startup and debugging application code executable by the JVM (e.g., using a separate table for each). The information stored in these additional tables may include dynamic values and the dynamic information in these tables may be automatically updated at appropriate stages of execution of the application by the JVM (e.g., upon JVM startup or application launch by the JVM). In addition to the reference and dynamic tables stored for each of the connection pools, the database may include functions for setting the properties of the respective connection pools. As will be described in further detail below, such functions may include logic for identifying the source (e.g., a particular JVM or client) from which each of the sessions may be originating. Additionally, these functions may include logic for defining an appropriate client identifier to be used in the database for each session.

Similar to the initial setup of the database layer, the initial setup of the application layer of the web application network system (e.g., network system 100 of FIG. 1), as described above, may include various initialization steps. In an example of such an initialization step, a database client may be installed on one or more application servers (e.g., of the application server system 200 of FIG. 2). The database client may be used by the application server (including its various JVMs) to establish a connection to the database in order to, for example, access application data or execute SQL queries. Other initialization steps that may be performed for the application layer may include, but are not limited to, specifying reference and log data for database connections or connection pools within the application server or, e.g., connection pool manager 330 of FIG. 3, as described above and setting up properties of the database connections/connection pools for each session.

In some implementations, a JVM startup script including the above-described initialization steps may be used for setting up the application layer. For example, the JVM startup script may be used to startup or launch the execution of each JVM on an application server. Once the JVM is started using this script, the script may be configured to set any required environment variables and then start the execution of application code at the JVM. The script may also establish the connection(s) to a connection pool associated with the JVM, which may, for example, correspond to the JVM-to-connection pool properties stored in the reference tables of the database layer, as described above. The script may be provided by, for example, a vendor or distributor of the particular JVM being used. Further, the JVM script may be executed as a background process by the application server such that the script continues to execute until, for example, the JVM is shutdown or crashes. The JVM may be shutdown, for example, either manually in response to a command from a system administrator or automatically based on code executing at the application server.

The above-described client identifier for the session may be determined during a period of time from the initial launch of the JVM via the startup script to the time at which the associated connection pool(s) for the JVM are allocated and thus, an application session is established. In an example, the connection pool may include an initialization routine that executes one or more pre-defined SQL statements to initialize one or more data connections to the database. The initialization routine may execute the SQL statements, for example, as soon as the session is established. Reference now is made to FIGS. 4-6 to provide additional description of the initialization and setup processes performed in the application and database layers, as described above.

FIG. 4 is a flowchart of an exemplary process 400 for initializing one or more database connections for a Java Virtual Machine (JVM) in the connection pooling system of FIG. 3 using a JVM startup script, as described above. For example, steps 402, 404, 406 and 408 of process 400 may be based on commands defined within the startup script. Prior to launching a JVM (step 406) in the application layer (e.g., within application server 320 of FIG. 2, as described above) of the network system, a database connection is established in step 402 for the database 340 (or the database server coupled thereto). As described above, the database connection may be established for a potential database user including various properties related to the connection. In step 404, a connection pool is initialized for the JVM based on various properties of the JVM that may be defined in the JVM startup script. Such properties may include, for example, identification information for identifying the particular application server (and cluster) hosting the JVM.

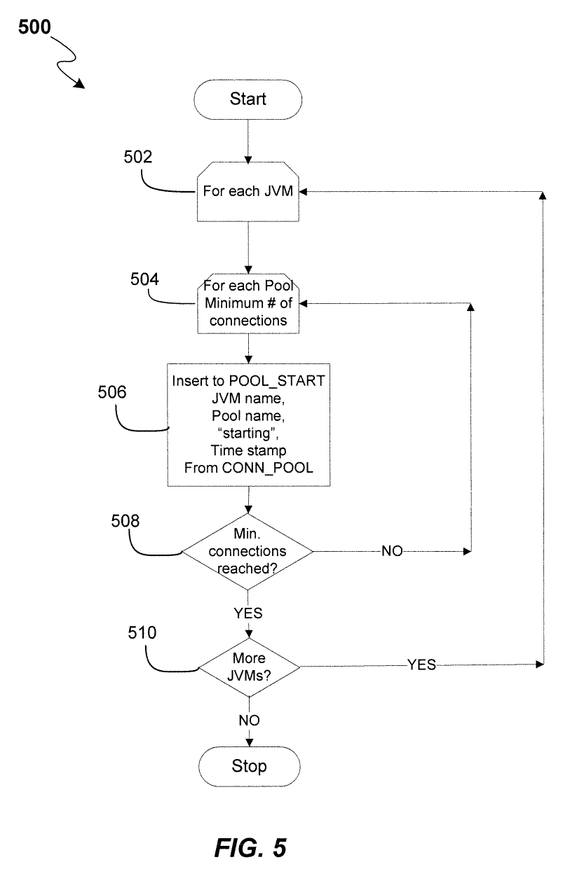

The connection pool for the JVM may be initialized using, for example, a process 500 of FIG. 5. For purposes of discussion, process 500 will be described with respect to SQL statements, but process 500 is not intended to be limited thereto and may be implemented using other types of database query or general programming languages. For example, a procedure including one or more SQL statements may be defined in the JVM startup script or other file within the database or database server in the database layer of the network system. The procedure may open, for example, an SQL (or SQL plus) connection to the database for executing one or more commands in the SQL statement(s). The connection may be closed subsequently, once the procedure has completed execution.

In the example of FIG. 5, the JVM to be started may be passed as an input argument to such a procedure. As shown in steps 502, 504 and 506 of process 500, an SQL statement including an “insert” command may be used to specify a name or other identifier for the JVM, the connection pool designated to the JVM and the minimum number of connections from that pool to be allocated for the JVM. This information may be provided in the startup script. Information identifying each JVM of an application server or server cluster in addition to the minimum number of connection pools allocated for the respective JVM may be inserted into a “POOL_START” table stored at the database. Further, the JVM information associated with each connection pool may be stored in the table in association with, for example and without limitation, a JVM name or other identifier, the name or identifier of the connection pool associated with that JVM, a status flag and a timestamp. The number of records inserted in the “POOL_START” table at this point may be equivalent to, for example, the number of minimum connection pools (and/or minimum number of database connections within each pool) that are allocated to the JVM. The information stored in the table can be used as a starting point for enabling session identification and tracing functionality.

Referring back FIG. 4, process 400 then proceeds from step 404 to step 406, in which the JVM is launched with one or more database connections selected from the connection pool initialized in step 404 (e.g., using process 500). As described above with the respect to the initialization steps performed for the application layer of the network system, the JVM may be started by a procedure included within the JVM startup script. This procedure may be configured to perform similar initialization steps including, for example, setting up any required environment variables and then, starting the execution of application code at the JVM. In step 408, this procedure may also be used to establish the database connection(s) to the connection pool initialized for the JVM. This may include defining, for example, JVM-to-connection pool properties associated with the JVM. As described above, such properties may be stored in the reference tables within the database layer of the network system. Like the procedure described above with the respect to process 500 of FIG. 5, the JVM startup procedure may perform the aforementioned initialization and JVM startup steps using one or more SQL statements/commands (e.g., via an SQL connection to the database).

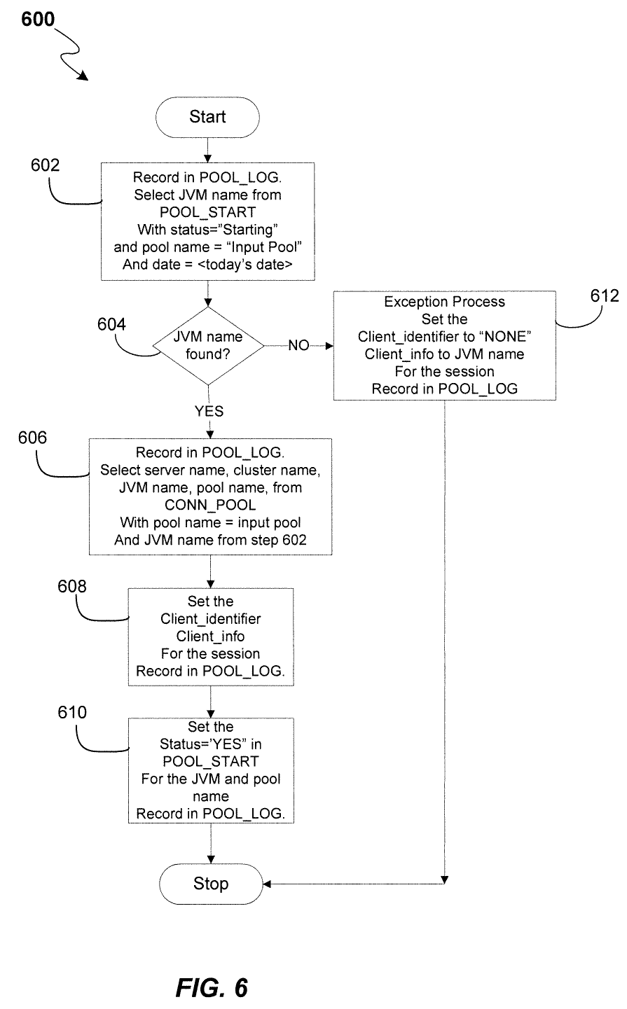

FIG. 6 is a flowchart of an exemplary process 600 for establishing one or more database connections from a connection pool associated with the JVM launched in step 408 of process 400 of FIG. 4. Like process 500, process 600 will be described by way of example in the context of a procedure including SQL statements. However, process 600 is not intended to be limited thereto and may be implemented using other types of database query or general programming languages. As shown in the example of FIG. 6, an entry in a “POOL_LOG” table may be recorded (step 602) for an input connection pool (“Input Pool”) having a timestamp corresponding to the current day's date. Process 600 checks the “POOL_START” table, as described above with respect to process 500 of FIG. 5, for any records having a status flag set to “Starting” on the same date. If a record is found (in step 604), it is logged or recorded in a “POOL_LOG” table (step 606), and application server (and server cluster) information associated with the JVM and corresponding to the record in the “POOL_START” table is retrieved. For example, the information may be retrieved from a reference table that is associated with the JVM and stored at the database, as described above. Process 600 may then use the specified JVM name (from step 602) for setting a client identifier and any additional information related to properties of the JVM (step 608). In some implementations, the JVM acts as or in place of the application client with respect to the database during the session. As such, the JVM performs operations to the database on behalf of the application client by using the input connection pool for this particular session of the web application. For example, the additional client information may include information identifying one or more of the application server, server cluster and connection pool associated with the JVM.

Once the client identification information is set for the session, process 600 may update the status flag of the record corresponding to the JVM and the associated connection pool within the “POOL_START” table to a value of “YES” (step 610), which indicates that one or more database connections from the relevant connection pool have been established for the corresponding JVM. In addition, a log entry may be made to a “POOL_LOG” table indicating the updated status for the NM. If no information is found for a JVM, an exception may be triggered and process 600 may handle the exception by setting the client identifier to, for example, a value of zero or “NONE” (step 612). Further, such exception handling may include setting the additional client information, as described above, to the name/identifier of the missing JVM, and adding a log entry in the “POOL_LOG” table indicating the occurrence of the exception.

The above-described steps of process 600 may be repeated for a single JVM as many times as the minimum number of connection pools allocated for that JVM or as the minimum number of database connections allocated from each connection pool. For example, a JVM configured to use a minimum number of five connections from a connection pool may cause at least some of the steps of process 600 to be performed five times so as to establish database connections in association with client identifiers corresponding to the five sessions that potentially may originate from the JVM with database connections from the particular connection pool remaining active concurrently during the same period of time. As described above, the JVM may be one of a plurality of JVMs executing at an application server, which may operate similar to an extended virtual machine for executing various functions of the web application in response to one or more requests from each of various application clients. The functions may include, for example and without limitation, establishing and managing back-end database connections in addition to front-end or client-side data connections to each of the various application clients via a network.

A benefit of processes 400, 500 and 600, as described above, includes providing a capability to trace all sessions with a greater degree of granularity so as to identify the system components (e.g., application server cluster, server, connection pool and JVM) associated with each session. This may in turn provide a database administrator the capability to identify and trace the execution path of a session through the network system, particularly with respect to specific JVM executing an instance of the web application being used during the session. For example, the database administrator may examine a session log file including information logged based on operations performed by each JVM during one or more sessions. The log file may include, for example and without limitation, information identifying the client from which a request for access to web application functionality may have been originated, the particular JVM that performed operations in response to the request, or the connection pool associated with that JVM. This enables the database administrator to identify and trace the execution path of different database operations performed during a given session so as to troubleshoot potential problems or system inefficiencies that may have been identified as occurring during the session (e.g., based data produced by system diagnostics tools used by the administrator). For example, a particular JVM may be identified as using a disproportionate amount of system resources or as the source of errors occurring during the session. Accordingly, the database administrator or administrative team may focus on troubleshooting the particular NM in question or application server executing that NM, rather than having to troubleshoot all of the application servers across one or more server clusters, as described above.

Furthermore, if any system modifications require the deployment of new code (e.g., new SQL statements), the new code can be deployed to only one JVM, and application sessions can be routed through that JVM for tracing the new execution of that code in the system in order to identify potential resource bottlenecks occurring in production. The traced data from various sessions, including multiple user transactions, can be analyzed to measure the effectiveness of the new code in sustaining current workload levels (e.g., based on a total number of network requests being processed) or handling an increased level of workload within the system.

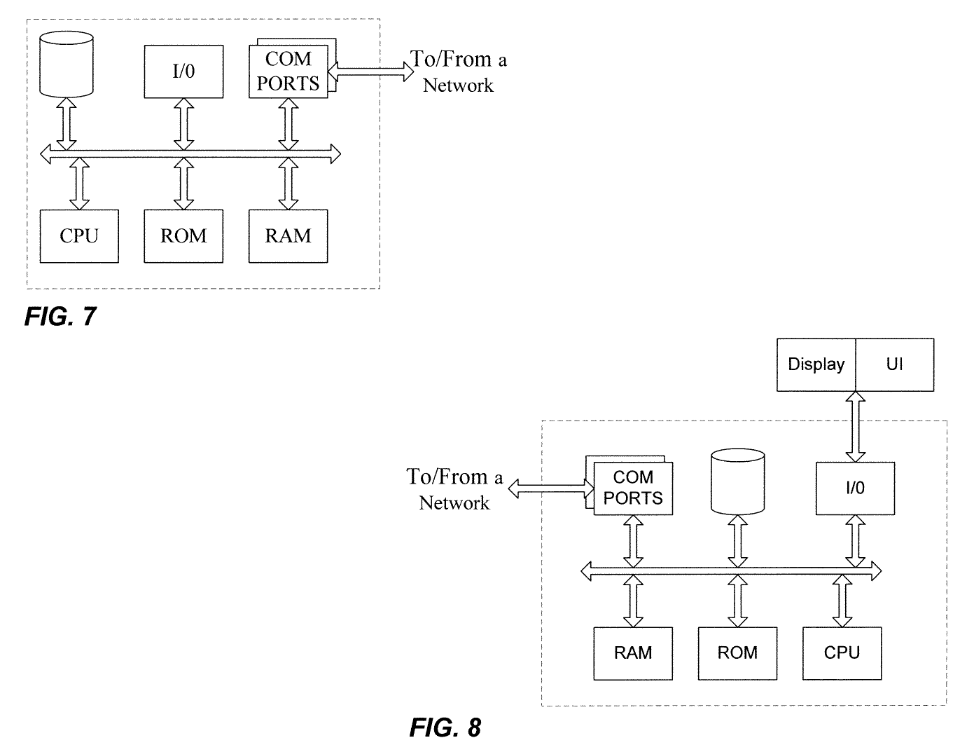

FIGS. 7 and 8 provide functional block diagram illustrations of general purpose computer hardware platforms. FIG. 7 illustrates a network or host computer platform, as may typically be used to implement a server (e.g., servers 140, 150 or 160 of FIG. 1, servers 212, 214, 216, 222, 224 and 226 of FIG. 2, and server 320 of FIG. 3, as described above). FIG. 8 depicts a computer with user interface elements, as may be used to implement a mobile device or personal computer (e.g., clients 110 or 120, respectively, of FIG. 1 and client 310 of FIG. 3, as described above). It is believed that the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

Hence, aspects of the methods of processes 400, 500 and 600 of FIGS. 4-6, respectively, as described above, may be embodied in programming. Program aspects of the technology may be thought of as “products” or “articles of manufacture” typically in the form of executable code or process instructions and/or associated data that is stored on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of a web application/service provider into the computer platform of the application or web server that will be hosting the web application/service.

Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as “computer’ or “machine readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the steps of processes 400, 500 and 600 of FIGS. 4-6, respectively. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

As noted above, the computer as illustrated in the example of FIG. 7 may be a mobile computer with user interface elements, as may be used to implement a laptop, tablet or notebook computer or the like. For example, such a device may include a touch-screen display for user input and output. Alternatively, the device may include a standard light emitting diode (LED) display and, for example, an alphanumeric keypad or T9 keyboard. It is believed that the structure, programming, and general operation of such computing equipment and as a result the drawing should be self-explanatory. As known in the data processing and communications arts, a mobile computer comprises a central processor or other processing device, an internal communication bus, various types of memory or storage media (RAM, ROM, EEPROM, cache memory, disk drives, etc.) for code and data storage, and one or more network interface cards or ports for communication purposes. Also, the mobile computer can further comprise various wireless transceiver modules (or components) such as GPS, WiFi, IrDA, Bluetooth, etc. The software functionalities involve programming, including executable code, associated stored data, and graphical user interface code for implementing a client application program at the mobile device. The software code is executable by the processor of the mobile computer. In operation, the code is stored within the mobile computer. At other times, however, the software may be stored at other locations and/or transported for loading into the appropriate mobile computer. Execution of such code by a processor of the mobile computer enables the mobile computer to implement the methodology for a client for requesting access to one or more functions offered by a web application or service, in essentially the manner performed in the implementation discussed and illustrated herein.

Further, the client can be implemented in a remote computer (or server) on a network. That is, a client device (e.g., mobile device) sends information (e.g., a request message) to the remote server for requesting access to a function of a web application hosted at the server; and the remote server processes the request based on the request received from the client and returns an appropriate response (e.g., including application data retrieved from a database) to the client over the network. In the example above, the client device operates as a client terminal and the remote computer as a server in a client-server network environment. While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
at a server hosting a web application receiving, through a communication network from a client, a request message requesting a function of the web application to be performed during a session of the web application;
establishing a plurality of data connections to a database for accessing data stored in the database during the session, based on the function of the web application requested by the request message;
initializing a connection pool including the plurality of established data connections for a virtual machine to be executed at the server, the connection pool enabling the virtual machine to access data stored in the database during the session;
initiating execution of the virtual machine at the server in order to perform operations for the requested function based on data retrieved from the database via at least one of the plurality of data connections of the connection pool initialized for the virtual machine, wherein reference and logging information for the connection pool are stored in the database, the stored reference and logging information enabling the operations performed by the virtual machine to be traced for the session of the web application; and
sending a response message from the server through the communication network to the client, based on the operations performed by the virtual machine for the function requested by the client during the session of the web application.

2. The method of claim 1, wherein the virtual machine is a Java Virtual Machine (JVM).

3. The method of claim 1, wherein the virtual machine is initiated based on commands in a startup script associated with the virtual machine.

4. The method of claim 3, wherein the initialized connection pool is allocated to the virtual machine based on properties defined in the startup script, the properties including a predetermined minimum number of data connections to be used by the virtual machine.

5. The method of claim 3, wherein the commands in the startup script are Structured Query Language (SQL) commands to be executed at the database.

6. The method of claim 1, wherein the connection pool is one of a plurality of connection pools allocated to the virtual machine for accessing data in the database during the session.

7. The method of claim 6, wherein the virtual machine is one of a plurality of virtual machines executing at the server, and each virtual machine of the server is allocated one or more of the plurality of connection pools during different sessions of the web application.

8. The method of claim 7, wherein the server is one of a plurality of servers within a clustered computing environment having one or more server clusters, each server in the clustered computing environment executing one or more virtual machines, and each of the one or more virtual machines is configured to perform operations during the different sessions of the web application.

9. The method of claim 8, wherein reference and logging information are stored for each of the plurality of connection pools in association with information identifying one or more of the plurality of virtual machines to which each connections pool is allocated and connection properties associated with each of the one or more virtual machines.

10. The method of claim 9, wherein the information identifying the one or more virtual machines includes information identifying the corresponding server in the clustered computing environment executing each of the respective one or more virtual machines.

11. The method of claim 9, wherein the connection properties associated with each of the one or more virtual machines include one or more of a status identifier, a timestamp, a session identifier identifying the session and a client identifier identifying the client associated with the requested function of the web application during the session.

12. An application server, comprising:
a network communication device configured to exchange data communications through a communication network, the communication network including at least one database accessible to the network communication device;
a processor coupled to the network communication device;
a storage device accessible to the processor; and
an application program in the storage device, the application program including a plurality of functions of a web application, wherein execution of the application program by the processor configures the application server to exchange data communications related to the plurality of functions with a client through the communication network,
wherein the processor is configured to perform functions, including functions to:
receive through the communication network from the client, a request message requesting at least one of the plurality of functions of the web application to be performed during a session of the web application;
establish a plurality of data connections to the database for accessing data stored in the database during the session, based on the function of the web application requested by the request message;
initialize a connection pool including the plurality of established data connections for a virtual machine to be executed by the processor, the connection pool enabling the virtual machine to access data stored in the database during the session;
initiate execution of the virtual machine in order to perform operations for the requested function based on data retrieved from the database via at least one of the plurality of data connections of the connection pool initialized for the virtual machine, wherein reference and logging information for the connection pool are stored in the database, the stored reference and logging information enabling the operations performed by the virtual machine to be traced for the session of the web application; and
transmit a response message through the communication network to the client, based on the operations performed by the virtual machine for the function requested by the client during the session of the web application.

13. An article of manufacture, comprising a non-transitory computer-readable medium and computer-executable instructions embodied in the medium that, if executed by a computing device, cause the computing device to perform functions, including functions to:
receive through a communication network from a client, a request message requesting a function of a web application hosted at the computing device to be performed during a session of the web application;
establish a plurality of data connections to a database for accessing data stored in the database during the session, based on the function of the web application requested by the request message;
initialize a connection pool including the plurality of established data connections for a virtual machine to be executed at the computing device, the connection pool enabling the virtual machine to access data stored in the database during the session;
initiate execution of the virtual machine at the computing device in order to perform operations for the requested function based on data retrieved from the database via at least one of the plurality of data connections of the connection pool initialized for the virtual machine, wherein reference and logging information for the connection pool are stored in the database, the stored reference and logging information enabling the operations performed by the virtual machine to be traced for the session of the web application; and
send a response message from the computing device through the communication network to the client, based on the operations performed by the virtual machine for the function requested by the client during the session of the web application.

14. The article of claim 13, wherein the virtual machine is a Java Virtual Machine (JVM).

15. The article of claim 13, wherein execution of the virtual machine is initiated based on commands in a startup script associated with the virtual machine.

16. The article of claim 15, wherein the initialized connection pool is allocated to the virtual machine based on properties defined in the startup script, the properties including a predetermined minimum number of data connections to be used by the virtual machine.

17. The article of claim 15, wherein the commands in the startup script are Structured Query Language (SQL) commands to be executed at the database.

18. The article of claim 13, wherein the connection pool is one of a plurality of connection pools allocated to the virtual machine for accessing data in the database during the session.

19. The article of claim 18, wherein the virtual machine is one of a plurality of virtual machines executing at the server, and each virtual machine of the server is allocated one or more of the plurality of connection pools during different sessions of the web application.

20. The article of claim 19, wherein reference and logging information are stored for each of the plurality of connection pools in association with information identifying one or more of the plurality of virtual machines to which each connection pool is allocated in addition to connection properties associated with each of the one or more virtual machines.
